(19) United States
(12) Patent Application Publication
(10) Pub. No.: US 2024/0070129 A1
(43) Pub. Date: Feb. 29, 2024

(54) Method and System for Automatic Data Analysis and Use of Machine Operation Data

(71) Applicant: CITYWIDE ELEVATOR CONSULTING LLC, BRIDGEWATER, NJ (US)

(72) Inventor: MICHAEL CLASS, FLEMINGTON, NJ (US)

(21) Appl. No.: 17/893,769

(22) Filed: Aug. 23, 2022

(51) Int. Cl. G06F 16/215; G06F 16/2455; G06F 16/248

(52) U.S. Cl. CPC G06F 16/215; G06F 16/24564; G06F 16/248

(57) ABSTRACT

A system and method for uploading data from data sources, cleaning and qualifying of the raw data to create queryable data; and analyzing the queryable data to determine patterns of the queryable data and predictive states of the queryable data. The system and method can include visualizing the queryable data, the patterns of the queryable data and predictive states of the queryable data at an user interface and generating reports in near-real time. The raw data can be directed to operations and maintenance of machine devices. The reports can include information directed to one or more machine devices which are in need of modernization, audit or upgrades or a targeted way of dealing with a predetermined condition, a budget estimate of the one or more machine devices in a portfolio based on the one or more machine devices and a single metric and a real dollar value (RDV) of the maintenance agreement.

### BACKGROUND OF THE INVENTION

### Field of the Invention

The present invention relates to automatically extracting information for analysis from raw data pipelines to create processed data and in particular to a cloud based system and method for automatically extracting information from raw data directed to building machine devices, such as for example an elevator or escalator, and using the created processed data for analysis in determining economics and reports directed to the need for modernization or upgrades of the machine devices.

### Description of Related Art

Conventional record keeping for machine devices can take many forms. Data directed to the operation of machine devices can be manually entered into data files. The data files for machine devices of elevators can include records from vendors related to how many device failures, entrapments and uncategorized shutdowns of the elevators have occurred. Conventional record keeping especially in the elevator service industry, has many shortcomings in that the record keeping is inadequate, often cryptic, with low quality of record-keeping.

Automatic methods for generating data of machine operations are known. U.S. Pat. No. 11,167,955 describes a method and a system for generating maintenance data of an elevator door system. The generated maintenance data may be used to detect the need for the maintenance, i.e. a failure, earlier than normally, such as during maintenance visits. The maintenance data may be generated remotely.

It is desirable to provide a method and system for automatically extracting information from raw data directed to building machine devices, such as for example an elevator or escalator, and using the created processed data for analysis in determining economics and reports directed to at risk devices which are in need of modernization, or upgrades or a targeted way of dealing with a specific issue, such as adding vandal resistant buttons in misuse prevention.

### SUMMARY OF THE INVENTION

The present invention relates to a method and system for automatically processing information from raw data sources and using the created processed data in analysis. In one embodiment the raw data sources include data directed to vertical transportation devices, such as for example an elevator or escalator, or other building machine devices. The analysis can include coordinated evaluation of elements of vertical transportation upkeep, such as maintenance, repair costs and the need for modernization or upgrades of the machine devices.

Due to the statistical foundation of the method, it is more effective when large amounts of data from one or more data sources are available for analysis. The method and system is expected to provide the most benefit when applied to a portfolio with a large number, for example more than 50, devices, and the devices have a sufficient history of maintenance activity, such as for example maintenance records for the most recent two years. Example data from devices can include, vendor information, number of devices, monthly vendor service provider costs, average price per device, maintenance agreement costs, time spent performing maintenance on devices, callback service to determine whether the cause is an equipment failure or an incident of misuse, or equipment failure information.

In one embodiment, the method includes uploading data from data sources into the cloud. The method may further comprise cleaning and normalizing of data, data qualification and normalization of the cleaned data and storing the data in a normalized and categorized format in the cloud. The method may further comprise performing an analysis to determines patterns and predictive states of the quality data. The method may further comprise visualizing the data at an user interface. The method may further comprise generating economic analytics and reports directed to the data. In one embodiment, reports are generated of at risk devices which are in need of modernization, or upgrades or a targeted way of dealing with a predetermined condition. The method may further comprise generating a single metric, of a real dollar value (RDV), of a service provider's agreement, taking into account the monthly cost, maintenance performance record, and the probable cost of out-of-contract work during the term of the agreement. The method may further comprise generating a report for a plurality of devices of value of maintenance agreements, need for capital improvement of the devices, and steps which can be taken to minimize overall cost for maintaining the devices.

The method may further comprise data lake formation for creating one or more data lakes configured to provide temporal storage, secure customer data storage and aggregate stores. The method may be implemented in a cloud processing platform configured to perform aggregate data compilation and computation of statistics of the data.

In one embodiment, a non-transitory computer readable storage medium is disclosed having computer readable code thereon for providing data analytics, the medium including instructions executable by one or more processors to perform operations, comprising: uploading data from data sources into the cloud, cleaning and normalizing of data, data qualification and normalization of the cleaned data and storing the data in a normalized and categorized format in the cloud. The non-transitory computer readable storage medium may further comprise instructions for performing an analysis to determines patterns and predictive states of the quality data. The non-transitory computer readable storage medium may further comprise instructions for visualizing the data at an user interface. and generating economic analytics and reports directed to the data.

The invention will be more fully described by reference to the following drawings.

### BRIEF DESCRIPTION OF THE DRAWINGS

FIG. 1 is a schematic view of a system for automatic data analysis and use of machine operation data.

FIG. 2 is a flow diagram of a system for automatic data analysis and use of machine operation data.

FIG. 3 is a schematic diagram of a system for automatic data analysis and use of machine operation data.

Embodiments of the present disclosure and their advantages are best understood by referring to the detailed description that follows. It should be appreciated that the figures may not be necessarily drawn to scale.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

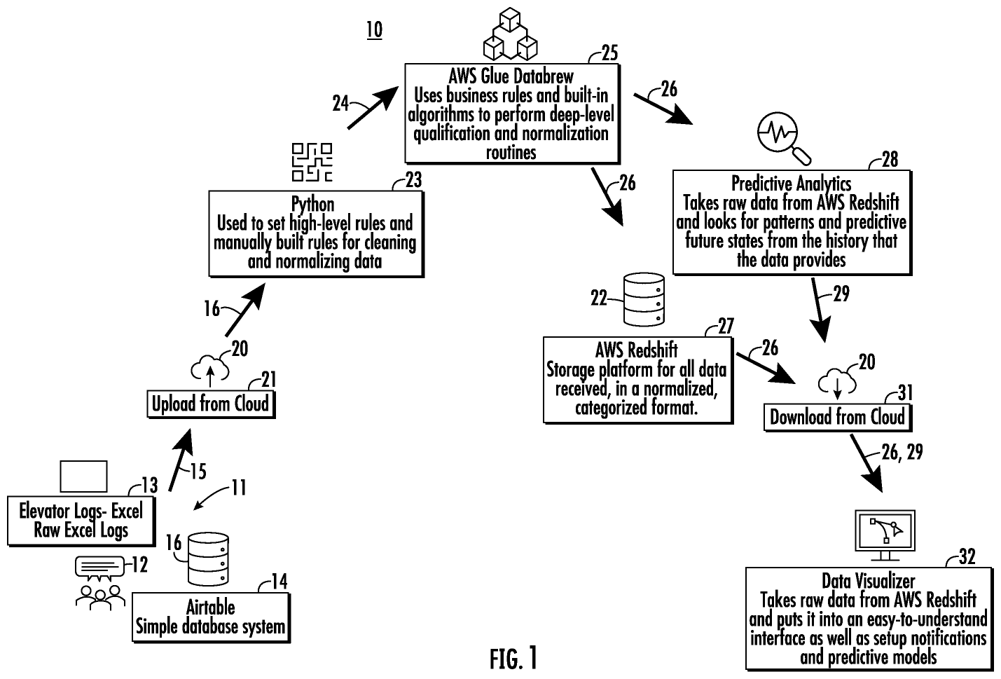

FIG. 1 is s a schematic view of system architecture for automatic data analysis and use of machine operation data 10. System architecture 10 includes data sources 11. Data sources 11 can include raw user data 12, collected raw data records 13 and stored raw data 14. Stored raw data 14 can be stored in one or more databases 15.

Data sources 11 can be in the form of a flat file or Excel. Data sources 11 can be directed to data from machine operations such as for example vertical transportation devices and other devices. Example vertical transportation devices include elevators and escalators. Data sources 11 can include data directed to vertical transportation device reliability derived from service provider's records of callbacks and entrapments. A callback is a call for service placed by a customer in the event of the vertical transportation device malfunction and/or shutdown. An entrapment is when an elevator stops with passengers inside for any amount of time, and the passengers cannot leave the elevator. Data sources 11 can also include data directed to maintenance of the devices and maintenance agreements for the devices. For example collected raw data records 13 can be Excel elevator logs of elevator operations and maintenance. Raw data records 13 can include, for example, data directed to total amount of callbacks received per device, amount of equipment failures received for each device, amount of misuse incidents received for each device and amount of entrapments that occurred at each device.

Data 16 from data sources 11 is uploaded to cloud 20 using upload module 21. Data 16 can include raw user data 12 and collected raw data records 13. Cleaning and qualifying module 23 and cleaning and qualifying module 25 perform cleaning and normalizing of data 16. Cleaning and qualifying module 23 and cleaning and qualifying module 25 can be rule based using high level rules and manually built rules for cleaning and normalization of data 16 into cleaned and normalized data 26. Cleaning and qualifying module 23 and cleaning and qualifying module 25 can use qualitative and quantitative techniques applied on data 16 to derive organizing and cleaning of data, to create a standard, query capable solution across a disparate field of sources of raw data. In one embodiment, cleaning and qualifying module 23 reviews data 16 ingested for recognized patterns that were previously put into system 10 in cleaning and qualifying module 23 and additionally reviews data 16 for expected information in a form of a required predetermined column data and/or expected data type in a column. An example of a function of cleaning and qualifying module 23 is to check for predetermined columns in data 16 and when a column required to upload data is not found in data 16 it triggers data 16 to be rejected. Another example of a function of cleaning and qualifying module 23 is to check for a predetermined data type in a column of data 16 and when for example data 16 includes a column with dates which includes a name in the column instead of a date, it triggers a rejection of data 16. Another example of a function of cleaning and qualifying module 23 is to check for duplicate data, such as data 16 including separate excels with overlapping timelines and events. Data 24 from cleaning and qualifying module 23 is then moved through process success state triggers to cleaning and qualifying module 25. Cleaning and qualifying module 25 performs quantifying of data 24 by normalizing into quality and queryable data 26. Quality and queryable data 26 is a data set meeting predetermined parameters. A quality check can be performed manually or automatically to confirm that quality and queryable data 26 has been cleaned correctly. Cleaning and qualifying module 25 can be developed or adjusted to improve the quality of quality and queryable data 26. Quality and queryable data 26 is stored in storage platform 27. Storage platform 27 can include one or more databases 22.

Predictive analytics module 28 provides data analytics to determine patterns and predictive states of quality and queryable data 26. In one embodiment, each callback is analyzed to determine whether the cause is an equipment failure, an incident of misuse, such as vandalism or unintentional misuse, or other. The relative frequency of equipment failures for each device can be analyzed for a recommendation to the customer to plan for modernization of the device. A comparative analysis of maintenance agreements can be performed to compare the services and prices offered by various service providers from service providers' records of time spent performing maintenance on the customers devices. The result of the analysis of predictive analytics module 28 can provide an informed recommendation for planning for major component replacements or extensive modernization of devices. Predictive analytics module 28 as a pattern recognition platform can identify like information, that does not appear to be impactful until analyzed. An example can be that a branch location performs more maintenance but devices are still failing at an increased rate. This can indicate an issue with this branch that needs to be addressed. Since all quality and queryable data 26 is queryable, predictive analytics module 28 provides an ecosystem to provide answers to previously unknown questions or issues or not typically addressed questions or issues.

Predictive analytics data 29 and quality and queryable data 26 can be downloaded from cloud 20 with download module 31. Data visualizer module 32 is an interface to predictive analytics data 29 and quality and queryable data 26. Data visualizer module 32 can also determine economics and reports directed to analytics data 29 and quality and queryable data 26. In one embodiment, reports are generated using data visualizer module 32 of at-risk devices which are in need of modernization, audit or upgrades or a targeted way of dealing with a predetermined condition. In one embodiment, the predetermined condition can be vandalism. In one embodiment, data visualizer module 32 can create an accurate budget estimate of one or more devices in a portfolio based on the one or more devices performance as a history derived from predictive analytics data 29 and quality and queryable data 26. In one embodiment data visualizer module 32 can create an accurate single metric, of a real dollar value (RDV), of a service provider's agreement, taking into account the monthly cost, maintenance performance record, and the probable cost of out-of-contract work during the term of the agreement.

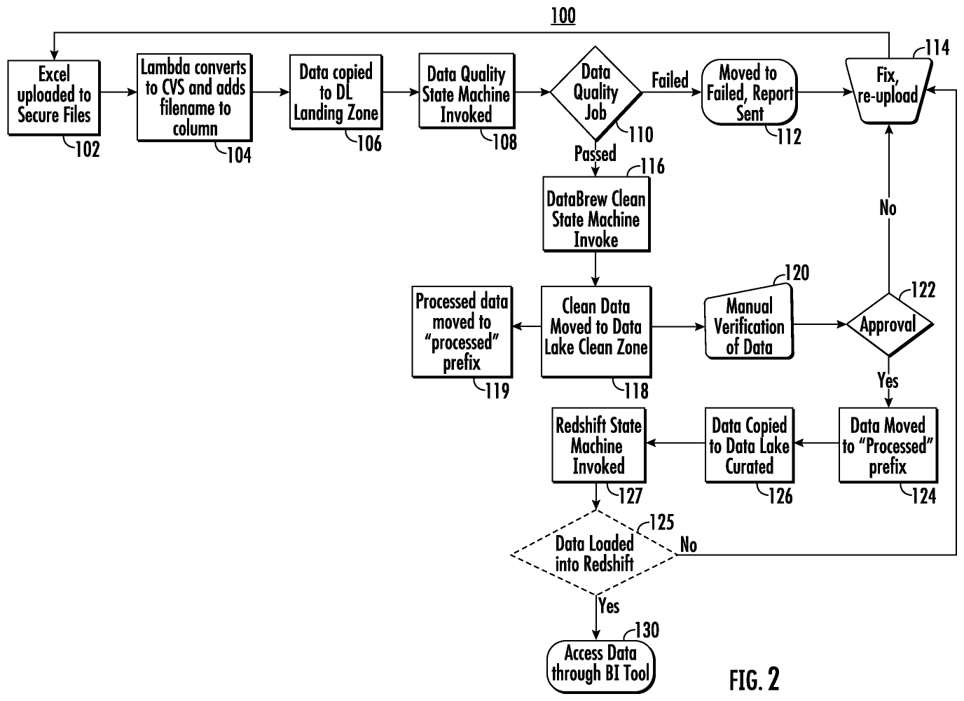

A flowchart of particular embodiment is depicted in FIG. 2. The rectangular elements are herein denoted “processing blocks” and represent computer software instructions or groups of instructions. Alternatively, the processing blocks represent steps performed by functionally equivalent circuits such as a digital signal processor circuit or an application-specific integrated circuit. The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring to FIG. 2, a particular embodiment of method for automatic data analysis and use of machine operation data 100 in near-real time is shown. Method 100 begins with processing block 102 receiving data from one or more data sources. In one embodiment, processing block 102 uploads a Excel file. In one embodiment the source data from one or more data sources can be presented in real time. In processing block 104, the uploaded data is converted to an efficient file format for data optimization without changing the contents of the data. In one embodiment, processing block 104 uses Lambda to convert the uploaded Excel file to a CSV file as converted data.

In processing block 106, the data from processing block 104 is copied to a data lake. The data lake being configured to provide temporal storage, secure customer data storage, and aggregate storage. In one embodiment, the data is copied to a data lake landing zone S3 bucket. Processing block 106 also adds a new column to the data which contains a filename of the current file for a AWS Redshift reference.

In processing block 108, data quality is performed to verify the data from processing block 106. In one embodiment, the data quality is determined using a data quality state machine. A decision is made in processing block 110 to determine if the quality of the data passes. When it is determined in processing block 110 that the quality check failed, the process ends. A notification email can be sent such as for example, via SNS. In processing block 114, data can be forward to processing block 102 for further processing.

When it is determined in the quality check block 110 that the quality check passed, processing block 116 is invoked to clean the data and transform the data into a format that can be used to perform data analysis queries. In one embodiment, a DataBrew clean job is run to transform the data into a format which can be used with AWS Redshift.

In processing block 118, cleaned and transformed data is moved to the data lake. In processing block 119, the processed data from block 118 is moved to a processed prefix within the data lake. Alternatively, processing block 120 performs manual verification of the processed data from block 118.

A decision is made in processing block 122 to determine if the manually verified data is approved. As additional qualifications and known quantifications occur during method 100, method 100 and system 10 will increase automation and decrease manual verification of processed data from block 118. When it is determined in processing block 122 that the approval failed, the process ends. A notification email can be sent such as for example, via SNS. Processing block 114 can be invoked to forward the data to processing block 102 for further processing. When it is determined in processing block 122 that the approval passed, processing block 124 is invoked to move the approved data to the data lake. In processing block 126 a copy of approved clean data is copied to the data lake in a lake curated zone.

In processing block 125, processed data from the data lake curated zone is loaded into a data warehouse. The data warehouse can analyze structured and semi-structured data across data warehouses. In one embodiment, the data warehouse is implemented as Amazon Redshift. Processing block 130 can be invoked to access data in the data warehouse. In one embodiment, Tableau is used to in processing block 130 to access the data stored in the data warehouse.

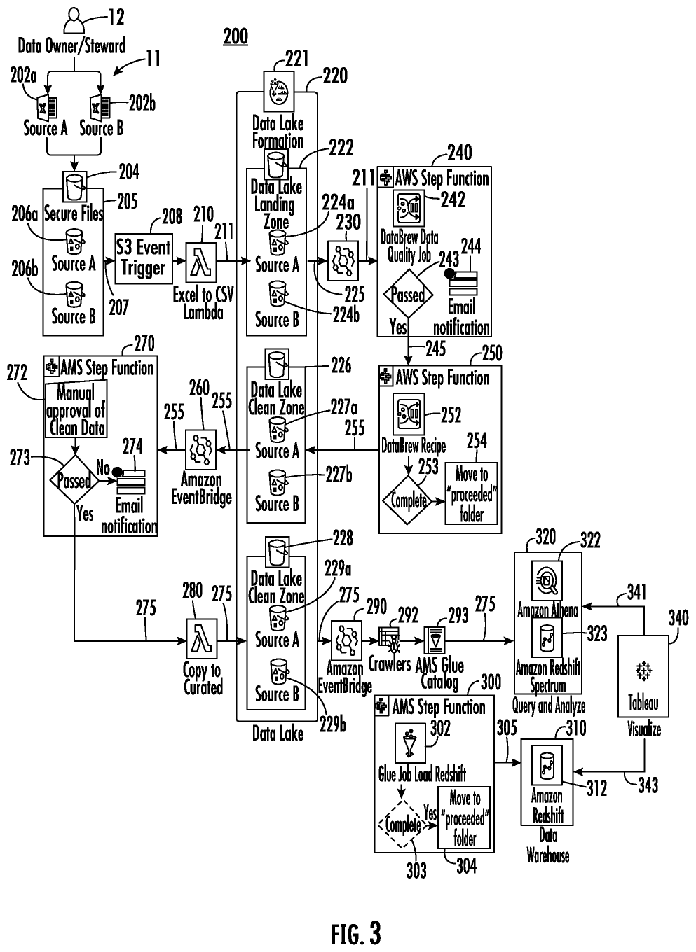

FIG. 3 is a schematic view of system architecture for automatic data analysis and use of machine operation data 200. System architecture 200 includes data sources 11 which can include data source 202a and data source 202b. Data source 202a and data source 202b can be in the form of a flat file or Excel. Data sources 202a and 202b can be directed to data from machine operations such as for example vertical transportation devices and other devices.

Data 204 from data source 202a and data source 202b is uploaded into cloud 205 into respective secure file container 206a and secure file container 206b. Data source 202a and 202b can be for example customer data vendor data and external data including customer portfolio information of building address and device identifiers, custom and vendor contracts, service provider's maintenance and repair records for each visit to each device. Secure file container 206a and secure file container 206b can be implemented with Amazon Web Services S3 (AWS) including AWS Simple Cloud Storage (S3). Secure file containers 206a, 206b can be AWS Secure Files buckets in S3. Data 204 can be a file in Excel format which is uploaded to the Secure Files bucket in S3.

Data pipe 207 from secure file containers 206a, 206b can be triggered by event trigger 208 to send data to conversion element 210. Trigger 208 can be a S3 event trigger. Conversion element 210 can be a Lambda function to convert data 204 of the Excel file received from data pipe 207 to CSV as converted data 211. Conversion element 210 is in communication with data storage and processing element 220. Data storage and processing element 220 can include formation and management element 221. In one embodiment, data storage and processing element 220 is a data lake with a plurality of zones and formation and management element 221 is AWS lake formation. Formation and management element 221 stores various versions of the same data sets, from unique stages in the process, including, raw, transformed, and cleaned Converted data 211 is copied to data lake landing zone 222 in secure file containers 224a, 224b.

Bridge element 230 receives converted data 211 for forwarding to data quality element 240. Bridge element 230 can be an Amazon event bridge. Data quality element 240 can include data quality job 242. Data quality job 242 can be a DataBrew data quality job which is run to verify the quality and accuracy of the data. A decision is made in decision element 243 to determine if the data quality is verified. If the quality check fails, message element 244 is invoked to send a notification and the job ends. In one embodiment, a notification email is sent out via SNS. If the quality check passes, verified quality data 245 is forwarded to clean data element 250. Clean data element 250 transforms verified data 245 into a format that can be used in analysis, such as for example Redshift. Clean data element can include clean job 252. Clean job 252 can be a DataBrew clean job to transform verified quality data 245 into the format that Redshift expects for queryable data. Element 253 determines when clean job 252 is complete and element 254 moves cleaned data 255 to secure source containers 227a, 227b of data lake clean zone 226.

Bridge element 260 receives cleaned data 255 for optionally forwarding to approval of clean data element 270. Bridge element 260 can be an Amazon event bridge. Approval of clean data element 270 can include manual approval of clean data element 272 in which a user manually reviews cleaned data 255. A decision is made in decision element 273 to determine if the cleaned data quality is verified. If the quality check fails, message element 274 is invoked to send a notification and the job ends. In one embodiment, a notification email is sent out via SNS. If the quality check passes, verified quality data 275 is forwarded using copy element 280 to secure source containers 229a, 229b of data lake curated zone 228.

Bridge element 290 receives verified quality data 275 for forwarding to crawlers element 292. Bridge element 290 can be a Amazon event bridge. Crawlers element 292 provides indexing of verified quality data 275 before forwarding using data glue element 293 to data load element 300 or query and analytics element 300. Data load element 300 include AWS step functions and state machines which trigger the next step of the procedure by qualifying a success state, and triggering the next process. In one embodiment cleaned data 255 receiving approval from manual approval of clean data element 272 forwards data to decision element 273. At decision element 273, a state machine of approval of clean data element 270 would consider cleaned data 255 to successfully completed a AWS step function and move verified quality data 275 to the next stage using copy element 280. Load element 302 can load verified quality data 275 into Redshift to create processed data 305. Load element 302 can be a AWS Glue load job. Element 303 determines when load element 302 is complete and element 304 moves processed data 305 to data warehouse 310. Data warehouse 310 can include one or more databases 312. In one embodiment a Redshift database and a SQL Database can be used for data warehouse 310. Databases 312 can be any data base such as Amazon supplied and supported database.

Query and analytics element 320 can query and analyze verified quality data 275 with data analytics. Query element 322 can be Amazon Athena to provide an interactive query service to analyze data directly using a query engine. Analysis element 323 can be Amazon Redshift Spectrum to pull data, filter, project, aggregate, group, and sort. Visualization element 340 can pull data 341 from query and analytics element 320 and data 343 from data warehouse 310. Visualization element 340 can be a graphical interface to visually interact with data 341 and data 343 for business intelligence including data analytics and business analytics. In one embodiment, visualization element 340 can be implemented in Tableau.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and system can generally be integrated together in a single software product or packaged into multiple software products.

The above-described features and applications can be implemented as software processes that are specified as a set of instructions recorded on a computer-readable storage medium (also referred to as computer readable medium). When these instructions are executed by one or more processing unit(s) (e.g. one or more processors, cores of processors, or other processing units), they cause the processing unit(s) to perform the actions indicated in the instructions. Examples of computer readable media include, but are not limited to, CD-ROMs, flash drives, hard drives, RAM chips, EPROMs, etc. The computer-readable media does not include carrier waves and electronic signals passing wirelessly or wired connections. Code may be written in any combination of programming languages or machine-readable data formats, each suitable to its particular application, including but not limited to: C, C++, Java, Python, Ruby, R, Lua, Lisp, Scala, JSON, JavaScript, YAML, XML, HTML, etc. Services may be RESTful and may be implemented using generic hooks, including over HTTP, HTTPS, SCTP, IP, TCP, JSON, JavaScript, etc., as well as via inter-process communication on one or more real or virtual machines or containers, e.g., IPC, shared memory, shared filesystem, UNIX pipes and the like. A Linux or POSIX environment may be used. A networking fabric may be provided among the different containers, in some embodiments. As is well-known, the benefit of using cloud infrastructure is that it is simple to mix heterogeneous resources and to scale services up or down based on load and desired performance.

In the specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronics systems, define one or more specific machine implementations that execute and perform the operations of the software programs.

A computer program (also known as program, software, software application, script, or code) can be written in any form of programming language, including compiled or interpreted languages, declarative or procedural languages, and it can be deployed in any form, including as a standalone program or as a module, component, subroutine, object, or another unit suitable for use in a computing environment. A computer program may, but need not correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

These functions described above can be implemented in digital electronic circuitry, in computer software, hardware, or firmware. The techniques can be implemented using one or more computer program products. Programmable processors and computers can be included in or packaged as mobile devices. The process and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), readable compact discs (CD-R), rewritable compact discs (CD-RW), read-only digital versatile discs (e.g., DVD-ROM, dual-layer DVD-ROM), a variety of recordable/rewritable DVDs (e.g. DVD-RAM, DVD-RW, DVD+RW, etc.), flash memory (e.g., SD cards, mini-SD cards, micro-SD cards, etc.), magnetic or solid-state hard drives, read-only and recordable Blu-Ray.R™. discs, ultra-density optical discs, any other optical or magnetic media, and floppy disks. The computer-readable media can store a computer program that is executed by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored in the circuit itself.

As used in this specification and any claims of this application, the terms “computer”, “server”, “processor”, and “memory” all refer to electronic or other technological devices. These terms exclude people or groups of people. For the purpose of the specification, the terms display or displaying means displaying on an electronic device. As used in this specification and any claims of this application, the terms “computer-readable media” and “computer readable medium” are entirely restricted to tangible, physical objects that store information in a form that is readable by a computer. These terms exclude any wireless, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, or any other available monitor types, for displaying information to the user and a keyboard and a pointing device, e.g., mouse or trackball, by which the user can provide input to the computer. Other kinds of devices can be used to provide for interaction with a user as well; for example, feedback provided to the user can be any form of sensory feedback, e.g., visual feedback, tactile feedback, or auditory feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication network include a local area network (“LAN”), an inter-network (e.g., the Internet), and peer-to-peer networks (e.g., ad-hoc peer-to-peer networks).

The subject matter described in this specification can be implemented using client-side applications, web pages, mobile web pages, or other software as generally known in the art and that would be usable to end-user customers (for community self-managed RAN apps) and/or mobile operator end users. The subject matter could alternately be delivered or implemented using an API, such as a SOAP API, a JSON API, a RESTful API, in lieu of or in conjunction with a direct end-user interface. The subject matter could use messaging queues, webhooks, server-side containers, or any other technology known in the art.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purpose of displaying data to and receiving user input from a user interacting with the client device). Data generated at the client device (e.g., a result of the user interaction) can be received from the client device at the server. Any database could be used (SQL, NoSQL, temporal, key-value, etc.).

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for automatically extracting from raw data information for analysis comprising the steps of:
receiving raw data from one or more data sources;
cleaning and qualifying of the raw data to create queryable data; and
analyzing the queryable data to determine patterns of the queryable data and predictive states of the queryable data.

2. The method of claim 1 further comprising the step of visualizing one or more of the queryable data, the patterns of the queryable data and predictive states of the queryable data at an user interface and generating reports of one or more of the queryable data, the patterns of the queryable data and predictive states of the queryable data in near-real time.

3. The method of claim 1 wherein cleaning and qualifying of the raw data is rule based using high level rules and manually built rules.

4. The method of claim cleaning and qualifying of the raw data comprises reformatting the raw data into another data format.

5. The method of claim 1 wherein the raw data is received in the cloud and further comprising creating a data lake for storing versions of the raw data and the queryable data.

6. The method of claim 1 wherein the raw data is has a data type of one or more Excel files and the cleaning and qualifying of the raw data processes information in a form of a required predetermined column data in the one or more Excel files and/or information of an expected data type in a column of the one or more Excel files.

7. The method of claim 1 wherein the raw data comprises data directed to operation of one or more machine devices and maintenance of the one or more machine devices and further comprising the step of visualizing one or more of the queryable data, the patterns of the queryable data and predictive states of the queryable data at an user interface and generating reports of one or more of the queryable data, the patterns of the queryable data and predictive states of the queryable data in near-real time wherein the reports include the one or more machine devices which are in need of modernization, audit or upgrades or a targeted way of dealing with a predetermined condition.

8. The method of claim 1 wherein the raw data comprises data directed to operation of one or more machine devices and maintenance of the one or more machine devices and further comprising the step of visualizing one or more of the queryable data, the patterns of the queryable data and predictive states of the queryable data at an user interface and generating reports of one or more of the queryable data, the patterns of the queryable data and predictive states of the queryable data in near-real time wherein the reports create a budget estimate of the one or more machine devices in a portfolio based on the one or more machine devices performance as a history derived from predictive analytics data from the step of analyzing the queryable data and the queryable data.

9. The method of claim 1 wherein the raw data comprises data directed to operation of one or more machine devices and maintenance of the one or more machine devices including monthly cost and maintenance performance record and further comprising the step of visualizing one or more of the queryable data, the patterns of the queryable data and predictive states of the queryable data at an user interface and generating reports of one or more of the queryable data, the patterns of the queryable data and predictive states of the queryable data in near-real time wherein the create a single metric, of a real dollar value (RDV), of the maintanence agreement, taking into account the monthly cost, maintenance performance record, and a probable cost of out-of-contract work during a term of the maintenance agreement.

10. A system for automatically extracting from raw data information for analysis comprising:
a memory; and
a computer processor that is programmed to:
receive raw data from one or more data sources;
clean and qualify the raw data to create queryable data; and
analyze the queryable data to determine patterns of the queryable data and predictive states of the queryable data.

11. The system of claim 10 wherein the system is configured to visualize one or more of the queryable data, the patterns of the queryable data and predictive states of the queryable data at an user interface and generating reports of one or more of the queryable data, the patterns of the queryable data and predictive states of the queryable data in near-real time.

12. The system of claim 10 wherein the raw data is cleaned and qualified into queryable data using high level rules and manually built rules.

13. The system of claim 10 wherein the system is configured to reformat the raw data into another data format.

14. The method of claim 10 wherein the raw data is received in the cloud and the system is configured to create a data lake for storing versions of the raw data and the queryable data.

15. The system of claim 10 wherein the raw data is has a data type of one or more Excel files and system is configured to process information in a form of a required predetermined column data in the one or more Excel files and/or information of an expected data type in a column of the one or more Excel files.

16. The system of claim 10 wherein the raw data comprises data directed to operation of one or more machine devices and maintenance of the one or more machine devices and the system is configured to visualize one or more of the queryable data, the patterns of the queryable data and predictive states of the queryable data at an user interface and to generate reports of one or more of the queryable data, the patterns of the queryable data and predictive states of the queryable data in near-real time wherein the reports include one or more items of the one or more machine devices which are in need of modernization, audit or upgrades or a targeted way of dealing with a predetermined condition, a budget estimate of the one or more machine devices in a portfolio based on the one or more machine devices performance as a history derived from predictive analytics data from the step of analyzing the queryable data and the queryable data and a single metric, of a real dollar value (RDV), of the maintenance agreement, taking into account the monthly cost, maintenance performance record, and a probable cost of out-of-contract work during a term of the maintenance agreement.

17. A non-transitory computer readable storage medium including instructions executable by one or more processors to perform steps comprising:
receiving raw data from one or more data sources;
receiving raw data from one or more data sources;
cleaning and qualifying of the raw data to create queryable data; and
analyzing the queryable data to determine patterns of the queryable data and predictive states of the queryable data.

18. The non-transitory computer readable storage medium of claim 17 further comprising the instructions for visualizing the data at an user interface. and generating economic analytics and reports directed to the data.

19. The non-transitory computer readable storage medium of claim 17 further comprising the instructions for reformating the raw data into another data format, and receiving the raw data in the cloud and creating a data lake for storing versions of the raw data and the queryable data.

20. The non-transitory computer readable storage medium of claim 17 wherein the raw data comprises data directed to operation of one or more machine devices and maintenance of the one or more machine devices and further comprising the instructions to visualize one or more of the queryable data, the patterns of the queryable data and predictive states of the queryable data at an user interface and to generate reports of one or more of the queryable data, the patterns of the queryable data and predictive states of the queryable data in near-real time wherein the reports include one or more items of the one or more machine devices which are in need of modernization, audit or upgrades or a targeted way of dealing with a predetermined condition, a budget estimate of the one or more machine devices in a portfolio based on the one or more machine devices performance as a history derived from predictive analytics data from the step of analyzing the queryable data and the queryable data and a single metric, of a real dollar value (RDV), of the maintenance agreement, taking into account the monthly cost, maintenance performance record, and a probable cost of out-of-contract work during a term of the maintenance agreement.
